(19) United States
(12) Patent Application Publication
(10) Pub. No.: US 2019/0232240 A1
(43) Pub. Date: Aug. 1, 2019

(54) NOVEL STIRRING AND MIXING DEVICE FOR THE CONTENTS OF FOOD PREPARATION CONTAINERS

(71) Applicant: Johnny Sungjae Song, Brooklyn, NY (US)

(72) Inventor: JOHNNY SUNGJAE SONG, BROOKLYN, NY (US)

(21) Appl. No.: 16/249,250

(22) Filed: Jan. 16, 2019

Related U.S. Application Data
(60) Provisional application No. 62/623,871, filed on Jan. 30, 2018.

(51) Int. Cl. B01F 7/00; B01F 15/00

(52) U.S. Cl. CPC B01F 7/001; B01F 7/00141; B01F 2215/0026; B01F 15/00681; B01F 7/0025

(57) ABSTRACT

A novel stirring and mixing device generally comprises at least one central blade holder with at least one extended arm that can interchangeably or permanently accept at least one stirring and mixing blade; at least one threaded spindle; and at least one thumbscrew locknut or other similar fasteners that may be the knob or handle of the lid of a food preparation container. Central blade holders of various sizes and shapes have extended arms of various sizes and shapes configured to interchangeably and adjustably accept stirring and mixing blades of various sizes and shapes. Various elements of the stirring and mixing device are configured with a threaded or unthreaded aperture to receive a threaded spindle that can adjustably maintain the position of the elements relative to one another and to the lid of the food preparation container as the elements rotate around the axis provided by the threaded spindle.

### CROSS-REFERENCE TO RELATED APPLICATIONS

This application claims the benefit of U.S. Provisional Patent Application Ser. No. 62/623,871 filed on Jan. 30, 2018. The disclosure of the above application is hereby incorporated by reference for all purposes.

### FIELD OF THE INVENTION

The present invention relates to novel stirring and mixing devices and apparatuses for stirring and mixing the content of food preparation containers such as pots and pans. More particularly, the invention relates to a stirring and mixing device that is capable of stirring and mixing the content of food preparation containers of various sizes and shapes without requiring the opening of the lid of the container, without requiring the use of food preparation utensils such as wooden spoons and ladles for stirring and mixing, and without requiring more than one hand during its operation.

### BACKGROUND

Cooking is part of people's everyday life. Cooking usually involves the use of food preparation containers such as pots and pans to stir, mix, and cook various food materials and ingredients. Such food materials and ingredients can be solids or liquids, and these materials and ingredients often require regular stirring and mixing to prevent their burning and ensure their proper cooking.

Stirring and mixing the content of food preparation containers is usually a straightforward procedure typically involving the use of one hand to lift the lid of the container and the use of the other hand to use a food preparation utensil such as a wooden spoon or ladle to stir or mix the content of the container. However, this typical procedure may become problematic for the food preparer when the preparer must simultaneously work on more than one task, such as when the preparer must stir or mix the content of the container to prevent the burning of the content while having to scramble an egg, since the preparer must stop one task to perform the other task. Here if one task takes too long to complete, then the performance or outcome of the other task may be jeopardized. Stirring and mixing a food preparation container also frequently requires the use of both hands because the lid of the container is typically placed on the container during the heating process, which requires one hand to lift the lid and the other hand to stir or mix the content of the container using a stirring or mixing utensil. In addition, the lid is often placed on the container during the heating process to prevent the unwanted escape of the moisture or vapor of the content of the container or to prevent the accidental spilling of the content. Therefore, the lifting of the lid to stir or mix the container content may lead to the unwanted escape of moisture of vapor or accidental spilling. Furthermore, typical stirring and mixing of the container content requires the use of food preparation utensils such as a wooden spoon or ladle, but the use of such utensils may cause the accidental dripping or spilling of the content remaining on the utensil onto surfaces of nearby objects such as ovens, countertops, and floors.

Certain stirring and mixing apparatuses have been developed for the automatic stirring and mixing of the content of food preparation containers. Such apparatuses are typically motorized and powered electronically and are configured to regularly stir and mix the container content automatically.

However, these apparatuses suffer many drawbacks that hinder the stirring and mixing of the container of food preparation containers. These apparatuses require electricity, so they can be used only when a source of electric power is available. Also, cooking typically involves sources of fire or heat, so having an electronic apparatus near such sources may increase the level of danger.

Another drawback is that the apparatuses are typically placed in the food preparation container with the lid not in place, and this may cause the unwanted escape of the moisture or vapor of the container content or the accidental spilling of the content. Also, the content of the food preparation container may vary in their characteristics such as density and liquidity, and as the content cooks, these characteristics may change, requiring variations in stirring and mixing in terms of the degree of force, speed, and direction, among others. Therefore, the apparatuses offering automatic stirring may not be able to accommodate such variations. All of these disadvantages work together to increase the difficulty in stirring and mixing the content of food preparation containers.

Therefore, a need exists in the field for novel stirring and mixing devices and apparatuses capable of enabling quick stirring and mixing. A further need exists for a stirring and mixing device that enables the user to use only one hand to stir and mix the content of the food preparation container. A further need also exists for a stirring and mixing device that enables the user to stir and mix the container content without having to open the lid of the container. Finally, there is also a need for a stirring and mixing device that enables the user to stir and mix the container content without having to use food preparation utensils such as a wooden spoon or ladle.

### SUMMARY OF THE INVENTION

The present invention relates to a device for stirring and mixing contents of food preparation containers, the device comprising (i) at least one central blade holder with at least one extended arm; (ii) at least one blade that is interchangeably or permanently attached to the extended arm; (iii) at least one fastener locknut; and (iv) at least one threaded spindle.

In an embodiment, the fastener locknut is a thumbscrew locknut that is configured as a knob or a handle of a lid of a food preparation container.

In another embodiment, the central blade holder is made from polytetrafluoroethylene, polyoxymethylene, or ultra-high molecular weight polyethylene configured to produce a suitable low-friction surface. In an embodiment, the fastener locknut is made from polytetrafluoroethylene, polyoxymethylene, ultra-high molecular weight polyethylene configured to produce a suitable low-friction surface.

The present invention also relates to a device for stirring and mixing contents of food preparation containers, the device comprising (i) at least one central blade holder with a round surface and with at least one extended arm; (ii) at least one blade that is interchangeably or permanently attached to the extended arm; (iii) at least one fastener locknut; and (iv) at least one threaded spindle.

The invention also relates to a device for stirring and mixing contents of food preparation containers, the device comprising (i) at least one central blade holder with at least one extended arm; (ii) at least one bearing; (iii) at least one washer; (iv) at least one blade that is interchangeably or permanently attached to the extended arm; (v) at least one fastener locknut; and (vi) at least one threaded spindle.

In an embodiment, the at least one bearing and the at least one washer are placed between the thumbscrew locknut and the central blade holder.

In another embodiment, the thumbscrew locknut is configured to rotate around an axis provided by the threaded spindle synchronously with the central blade holder through the use of the at least one bearing and the at least one washer.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an exploded perspective view of one example of a stirring and mixing device according to various embodiments of the present invention.

FIG. 2 illustrates a perspective view of one example of a stirring and mixing device according to various embodiments described herein.

FIG. 3 shows a view of one side profile of one example of a stirring and mixing device that is attached to the lid of the food preparation container according to various embodiments described herein.

FIG. 4 depicts an example of a side profile view of one example of a stirring and mixing device and three exemplary stirring and mixing blades according to various embodiments described herein.

FIG. 5 depicts an exploded perspective view of another example of a stirring and mixing device featuring a central blade holder with a round surface according to various embodiments described herein and a view of one side profile of this example of a stirring and mixing device attached to the lid of the food preparation container according to various embodiments described herein.

FIG. 6 depicts an exploded perspective view of another example of a stirring and mixing device featuring bearings and washers placed between a central blade holder and a thumbscrew locknut according to various embodiments described herein and a view of one side profile of this example of a stirring and mixing device attached to the lid of the food preparation container according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit, and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New stirring and mixing devices, apparatuses, and methods for stirring and mixing the content of food preparation containers are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

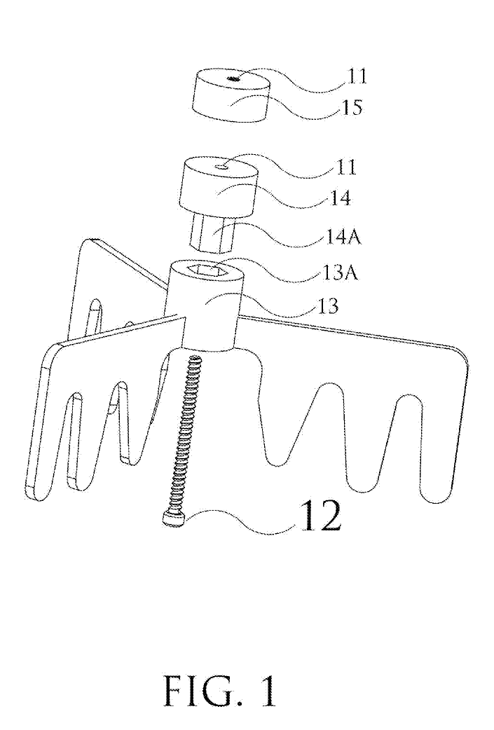

The present invention will now be described by referencing the appended figures representing preferred embodiments. FIG. 1 depicts an exploded perspective view of the elements that may comprise an example of a stirring and mixing device (the “device”) according to various embodiments of the present invention. In preferred embodiments, each of the elements of the device is configured with at least one fastener aperture 11, which is configured to accept a threaded spindle 12. Fastener apertures 11 may be threaded or unthreaded. Unthreaded fastener apertures 11 allow multiple components of the device (“elements”) to slide freely along the length of the threaded spindle 12 and may be of varying sizes. The threaded spindle 12 may be a bolt type, screw type, stud type, or any other suitable threaded fastener. Therefore, each element may be positioned along the length of the threaded spindle 12, in addition to being able to rotate around the axis provided by the threaded spindle 12.

In preferred embodiments, a central blade holder 14 may be configured with at least one extended arm 14A. In the embodiment depicted, the extended arm 14A is shown as a male member that can be snugly inserted into the blade opening 13A of a stirring and mixing blade 13, which is shown as a female member, thereby interchangeably and adjustably locking the stirring and mixing blade 13 into some desired angles and positions. Once the central blade holder 14 and the stirring and mixing blade 13 are interchangeably and adjustably locked into place, they move together as a single unit. In preferred embodiments, the extended arm 14A and the blade opening 13A have various matching shapes and sizes to allow for the stirring and mixing blade 13 to be positioned at different angles. In preferred embodiments, central blade holders 14 and extended arms 14A are interchangeable and of assorted lengths, shapes, and sizes to accommodate different sizes and shapes of stirring and mixing blades 13 and food preparation containers. In preferred embodiments, stirring and mixing blades 13 are interchangeable and of assorted lengths, shapes, and sizes to accommodate different sizes and shapes of food preparation containers. The central blade holder 14 may be threaded or unthreaded. In some embodiments, the central blade holder 14 and the stirring and mixing blade 13 may be a single permanently attached unit of various sizes and shapes.

In preferred embodiments, a thumbscrew locknut 15 or other similar fasteners, with a threaded fastener aperture 11, are configured to rotate around the axis provided by the threaded spindle 12 in concert with the central blade holder 14, and in such preferred embodiments, the central blade holder 14 may be threaded to allow for it to move together with the threaded thumbscrew locknut 15 as a single unit.

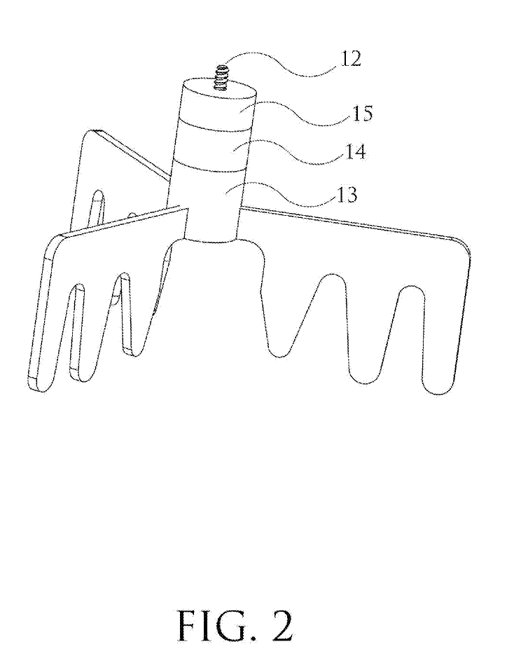

As perhaps best shown in FIG. 2, the elements of the device are configured to be positioned along the threaded spindle 12. In the preferred embodiment shown, when the thumbscrew locknut 15 is adjustably tightened, the user may rotate the central blade holder 14 and the stiffing and mixing blade 13 around the axis provided by the threaded spindle 12 by rotating the thumbscrew locknut 15. In preferred embodiments, the thumbscrew locknut 15 may be the knob or handle of the lid of a food preparation container.

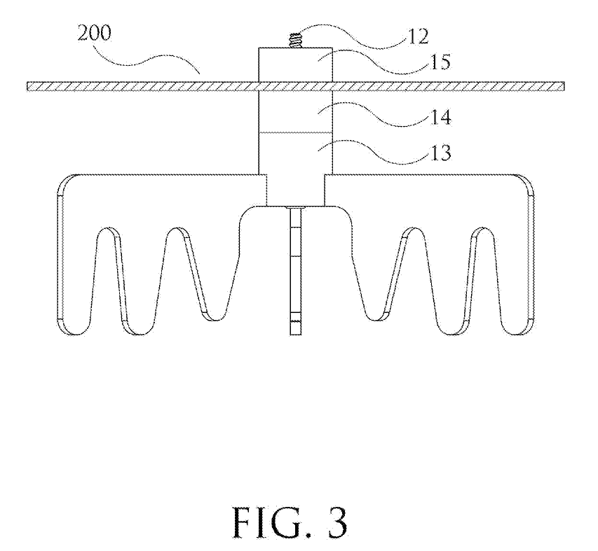

In the preferred embodiment shown in FIG. 3, the device may be attached to the food preparation container lid 200 by placing a holed lid 200 between the threaded central blade holder 14 and the thumbscrew locknut 15. In the example embodiment, when the thumbscrew locknut 15 is adjustably tightened such that the lid 200 still remains free to rotate around the axis provided by the threaded spindle 12 independently of the central blade holder 14 and the thumbscrew locknut 15 then all elements of the stirring and mixing device move freely as a single unit independently of the lid 200. Therefore, in this example embodiment, even when the lid 200 is held in place to be immobile, the user may still freely rotate the central blade holder 14 and the stirring and mixing blade 13 around the axis provided by the threaded spindle 12 by rotating the thumbscrew locknut 15. The entire central blade holder 14 or portions of its surface may be made from polytetrafluoroethylene, polyoxymethylene, ultra-high molecular weight polyethylene, or other similar or suitable materials that may produce a suitable low-friction surface. The entire thumbscrew locknut 15 or portions of its surface may be made from polytetrafluoroethylene, polyoxymethylene, ultra-high molecular weight polyethylene, or other similar or suitable materials that may produce a suitable low-friction surface.

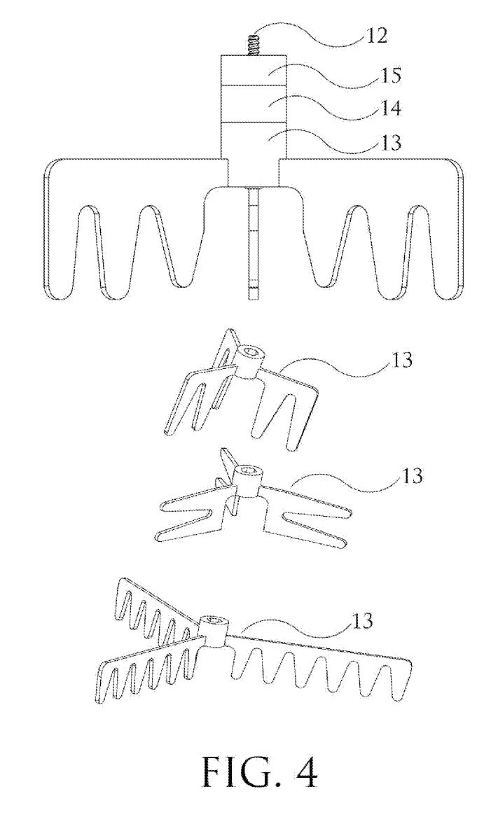

FIG. 4 illustrates a side profile view of an example of the stirring and mixing device according to the present invention. In this embodiment shown, four stirring and mixing blades 13, with one positioned on the threaded spindle 12, are provided. In preferred embodiments, the device may be reconfigured with one or more stirring and mixing blades 13 of assorted sizes and shapes and one or more central blade holders 14 of assorted sizes and shapes to accommodate varying shapes and sizes of food preparation containers.

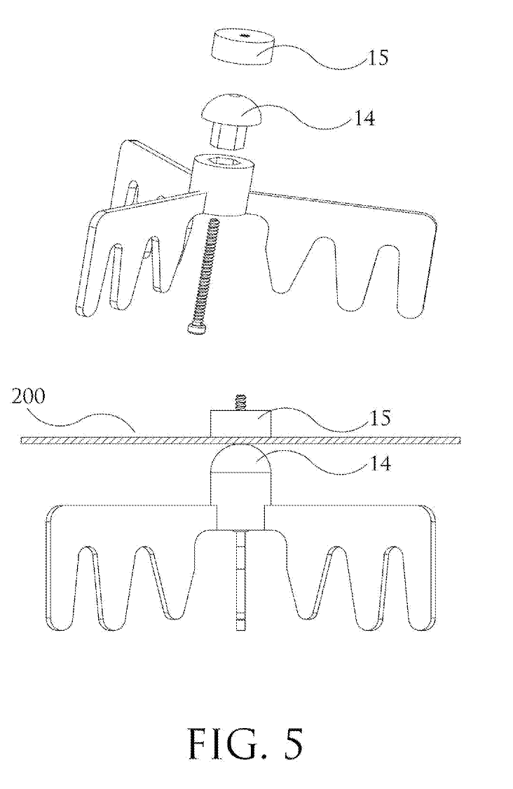

FIG. 5 illustrates an exploded perspective view of another example of a stirring and mixing device featuring a central blade holder 14 with a round surface according to the present invention and a view of one side profile of this example of the device attached to the lid 200 of a food preparation container according to the present invention. In this example embodiment shown, the round surface design of the central blade holder 14 produces a smaller contact surface area relative to the lid 200, facilitating smoother and easier rotation of the device relative to the lid 200.

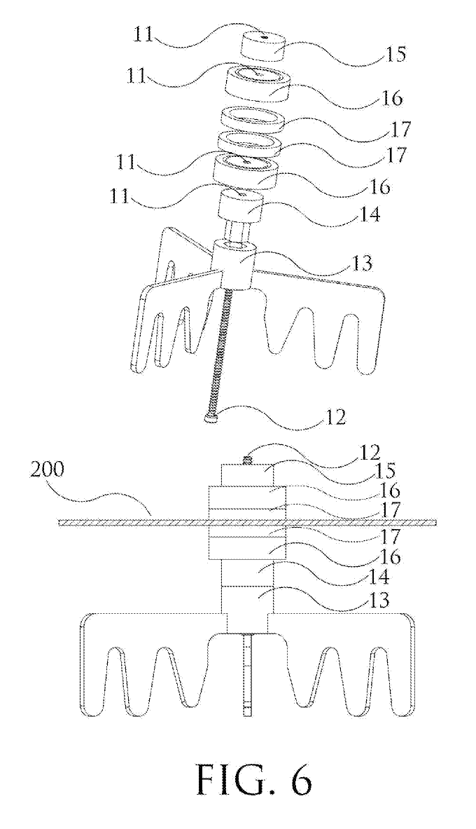

FIG. 6 illustrates an exploded perspective view of another example of a stirring and mixing device featuring bearings and washers placed between a central bladeholder 14 and a thumbscrew locknut 15 according to the present invention and a view of one side profile of this example of the device attached to the lid 200 of a food preparation container according to the present invention, in this example embodiment shown, a thumbscrew locknut 15 is configured to rotate around the axis provided by the threaded spindle 12 in sync with the central blade holder 14 through the use of two bearings 16 and two washers 17, which are placed in between the thumbscrew locknut 15 and the central blade holder 14. In this example embodiment shown, the central blade holder 4 with a central fastener aperture 11 has the same outer diameter as the shoulder diameter of the inner ring of the bearing 16, and the bearing 16 has a bore whose diameter matches the thread diameter of the threaded spindle 12. In preferred embodiments, the outer diameter of the washer 17 is the same as the outer diameter of the bearing 16, and the inner diameter of the washer 17 is the same as the shoulder diameter of the outer ring of the bearing 16. In preferred embodiments, the thumbscrew locknut 15 has the same outer diameter as the shoulder diameter of the inner ring of the bearing 16. In the example embodiment, even when the thumbscrew locknut 15 is firmly tightened, the lid 200, the outer rings of bearings 16, and the washers 17 rotate together as a single unit independently of remaining elements of the stirring and mixing device because the outer rings of bearings 16 are in contact with washers 17 and the lid 200 but not with other elements of the device, allowing the outer and inner rings of the bearings 16 and their respective in-contact elements to move freely and independently of each other. Therefore, in this example embodiment, even when the lid 200, the outer rings of bearings 16, and the washers 17 are held in place to be immobile as a single unit, the user may still freely rotate the central blade holder 14 and the stirring and mixing blade 13 around the axis provided by the threaded spindle 12 by rotating the thumbscrew locknut 15. This example embodiment allows the user to tightly screw the thumbscrew locknut 15 and still freely and easily rotate the central blade holder 14 and the stirring and mixing blade 13 around the axis provided by the threaded spindle 12 by rotating the thumbscrew locknut 15

All elements of the stirring and mixing device described herein are not limited by the type of material used, and desired materials may comprise some or all of the elements of the device in various embodiments of the present invention.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A device for stirring and mixing contents of food preparation containers, the device comprising:
a) at least one central blade holder with at least one extended arm;
b) at least one blade that is interchangeably or permanently attached to the extended arm;
c) at least one fastener locknut; and
d) at least one threaded spindle.

2. The device of claim 1, wherein the fastener locknut is a thumbscrew locknut that is configured as a knob or a handle of a lid of a food preparation container.

3. The device of claim 1, wherein the central blade holder is made from polytetrafluoroethylene, polyoxymethylene, or ultra-high molecular weight polyethylene configured to produce a suitable low-friction surface.

4. The device of claim 1, wherein the fastener locknut is made from polytetrafluoroethylene, polyoxymethylene, ultra-high molecular weight polyethylene configured to produce a suitable low-friction surface.

5. A device for stirring and mixing contents of food preparation containers, the device comprising:
a) at least one central blade holder with a round surface and with at least one extended arm;
b) at least one blade that is interchangeably or permanently attached to the extended arm;
c) at least one fastener locknut; and
d) at least one threaded spindle.

6. The device of claim 5, wherein the fastener locknut is a thumbscrew locknut that is configured as a knob or a handle of a lid of a food preparation container.

7. A device for stirring and mixing contents of food preparation containers, the device comprising:
a) at least one central blade holder with at least one extended arm;
b) at least one bearing;
c) at least one washer;
d) at least one blade that is interchangeably or permanently attached to the extended arm;
e) at least one fastener lockout; and
f) at least one threaded spindle.

8. The device of claim 7, wherein the fastener locknut is a thumbscrew locknut that is configured as a knob or a handle of a lid of a food preparation container.

9. The device of claim 7, wherein the at least one bearing and the at least one washer are placed between the thumbscrew locknut and the central blade holder.

10. The device of claim 7, wherein the thumbscrew locknut is configured to rotate around an axis provided by the threaded spindle synchronously with the central blade holder through the use of the at least one bearing and the at least one washer.
